(19) United States
(12) Patent Application Publication
(10) Pub. No.: US 2011/0142037 A1
(43) Pub. Date: Jun. 16, 2011

(54) METHOD, SYSTEM AND APPARATUS FOR CONTROLLING PLAY OF CUSTOMIZED RING BACK TONE SERVICE

(76) Inventors: Jian Yang, Shenzhen (CN); Guoqiao Chen, Shenzhen (CN)

(21) Appl. No.: 13/032,372

(22) Filed: Feb. 22, 2011

Related U.S. Application Data
(63) Continuation of application No. PCT/CN2009/073062, filed on Aug. 4, 2009.

(30) Foreign Application Priority Data
Aug. 22, 2008 (CN) 200810210298.3

(51) Int. Cl. H04L 12/66; H04M 3/42

(52) U.S. Cl. 370/352; 379/207.16

(57) ABSTRACT

A method, a system, and an apparatus for controlling play of a Customized Ring Back Tone (CRBT) service are disclosed. The method may be: receiving a play control instruction sent by a CRBT receiving terminal; and sending a CRBT to the CRBT receiving terminal according to the play control instruction. The system may include: a CRBT receiving terminal, configured to send a play control instruction to a CRBT platform, and obtain a CRBT sent by the CRBT platform according to the play control instruction; and a CRBT platform, configured to send the CRBT to the CRBT receiving terminal according to the play control instruction. A User Equipment (UE) and a CRBT platform are also disclosed. Through the information interaction between the CRBT receiving terminal and the CRBT playing terminal, the CRBT receiving terminal can control the play of the CRBT, and the user experience of the CRBT receiving terminal is improved.

### CROSS-REFERENCE TO RELATED APPLICATIONS

This application is a continuation of International Application No. PCT/CN2009/073062, filed on Aug. 4, 2009, which claims priority to Chinese Patent Application No. 200810210298.3, filed on Aug. 22, 2008, both of which are hereby incorporated by reference in their entireties.

### FIELD OF THE DISCLOSURE

The present disclosure relates to communication technologies, and in particular, to a method, a system, and an apparatus for controlling play of Customized Ring Back Tone (CRBT) services.

### BACKGROUND

The CRBT service enables a user to customize the ring back tone played on the User Equipment (UE) of the user as required. The ring back tone may be music, an advertisement, or a speech recorded by the user. The CRBT service is applicable to all mobile and fixed telephone users.

A Customized Ring Tone (CRT) service enables a user to customize the ring tone played on the UE of the user as required. The ring tone may be music, an advertisement, or a speech recorded by the user.

A Customized Background Tone (CBT) service enables a user to customize a background tone for a call as required by both parties to the call. A background tone may be music, an advertisement, or a speech recorded by the user.

The foregoing CRBT services fall within the audio CRBT category, and can be implemented through the existing audio system after the existing speech system is renovated. The CRBT service is a collective term of the foregoing three services.

A Customized Multimedia Ring back tone (CMR) service is customized by the called party in the videophone service, and provides a colorful and euphonic multimedia video for the calling party in place of the ordinary ring back tone while the called party rings after the calling party originates a call to the called party through a videophone.

The CMR is: After the calling party originates a call to the called party, if the called party has subscribed to the CMR service, the CMR customized by the called party replaces the ring back tone played while the calling party waits for the called party to answer the call. The CMR service may also play the corresponding CRBT file to the calling party according to conditions preset by the called party. For example, different CRBT files are played to different calling parties, or different CRBT files are played in different time segments.

In the CRBT service in the prior art, the called party subscribes to the CRBT service, and the calling party receives and plays the CRBT, and the media are not handed over to the called party until the called party goes off-hook. In the CRT service, the calling party subscribes to the CRT service. In the ringing process, the CRBT customized by the calling party is played on the UE of the called party. When the called party goes off-hook, the ring tone stops and the media are connected up between the calling party and the called party normally.

In the process of implementing the present disclosure, the inventor finds at least these problems in the prior art: The CRBT receiving terminal receives the CRBT passively, and the CRBT is played automatically. However, the CRBT receiving terminal who perceives the CRBT directly is unable to control the play of the CRBT, which deteriorates the experience of the CRBT receiving terminal massively.

### SUMMARY OF THE DISCLOSURE

Embodiments of the present disclosure provide a method, a system, and an apparatus for controlling play of CRBT services to improve the experience of the CRBT receiving terminal.

To fulfill the foregoing objectives, a method for controlling play of a CRBT service in an embodiment of the present disclosure is realized through the following technical solution: receiving a play control instruction sent by a CRBT receiving terminal; and sending a CRBT to the CRBT receiving terminal according to the play control instruction.

A system for controlling play of a CRBT service in an embodiment of the present disclosure includes: a CRBT receiving terminal, configured to: send a play control instruction to a CRBT platform, and obtain a CRBT sent by the CRBT platform according to the play control instruction; and the CRBT platform, configured to send the CRBT to the CRBT receiving terminal according to the play control instruction.

A UE provided in an embodiment of the present disclosure includes: a control instruction sending unit, configured to send a play control instruction to a CRBT platform; and a CRBT receiving unit, configured to obtain a CRBT sent by the CRBT platform according to the play control instruction.

A CRBT platform provided in an embodiment of the present disclosure includes: a control instruction receiving unit, configured to receive a play control instruction sent by a CRBT receiving terminal; and a CRBT sending unit, configured to send a CRBT according to the play control instruction.

The foregoing technical solution brings these benefits: Through the information interaction between the CRBT receiving terminal and the CRBT playing terminal, the CRBT receiving terminal can control the play of the CRBT, and the user experience of the CRBT receiving terminal is improved.

### BRIEF DESCRIPTION OF THE DRAWINGS

FIG. 1 is a flowchart of a first method embodiment of the present disclosure;

FIG. 2 is a flowchart of a second method embodiment of the present disclosure;

FIG. 3 is a flowchart of a third method embodiment of the present disclosure;

FIG. 4 is a flowchart of a fourth method embodiment of the present disclosure;

FIG. 5 is a flowchart of a fifth method embodiment of the present disclosure;

FIG. 6 is a flowchart of a sixth method embodiment of the present disclosure;

FIG. 7 is a schematic view showing a play control menu in a ninth method embodiment of the present disclosure;

FIG. 8 is a schematic view showing composition of a system in a tenth embodiment of the present disclosure;

FIG. 9 is a schematic view showing a structure of a UE in an eleventh embodiment of the present disclosure;

FIG. 10 is a schematic view showing a structure of a UE in a twelfth embodiment of the present disclosure;

FIG. 11 is a schematic view showing a structure of a CRBT platform in a thirteenth embodiment of the present disclosure; and

FIG. 12 is a schematic view showing a structure of a CRBT platform in a fourteenth embodiment of the present disclosure.

### DETAILED DESCRIPTION OF THE EMBODIMENTS

The embodiments of the present disclosure provide a method for controlling play of a CRBT service to improve the user experience of the CRBT receiving terminal.

### Embodiment 1

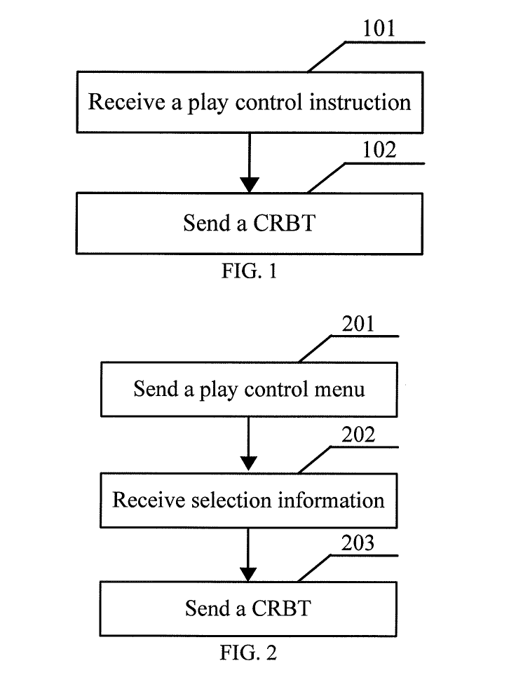

As shown in FIG. 1, a method for controlling play of a CRBT service in this embodiment includes the following steps:

Step 101: Receive a play control instruction sent by a UE, where the UE is a CRBT receiving terminal and may be a calling party or a called party. In the subsequent embodiments, more detailed instances will be given.

The received play control instruction may be carried through a protocol field or in other modes. For example:

The play control instruction is carried through different Session Initiation Protocol (SIP) header fields.

Or the play control instruction is carried through an Extensible Markup Language (XML) document. The XML document may be further carried through a Hyper Text Transfer Protocol (HTTP) field. It is understandable that the play control instruction may be sent in many modes, and the examples of the sending mode above shall not be construed as limitations to the present disclosure.

Step 102: Send a CRBT to the UE according to the play control instruction.

Through the information interaction between the CRBT receiving terminal and the CRBT playing terminal in the foregoing embodiment, the CRBT receiving terminal can control the play of the CRBT, and the user experience of the CRBT receiving terminal is improved.

### Embodiment 2

As shown in FIG. 2, the foregoing embodiment may be extended as follows:

Step 201: Send a play control menu to a UE.

The sending of the play control menu to the UE may be:

sending the play control menu carried in a Circuit Switched (CS) protocol, or sending the play control menu carried in a Packet Switched (PS) protocol.

The mode of carrying the play control menu in the CS protocol may be:

carrying the play control menu through the Dual Tone Multi Frequency (DTMF), or Short Message Service (SMS), or Unstructured Supplementary Service Data (USSD), or supplementary service indication message such as a Facility message.

The mode of carrying the play control menu in the PS protocol may be: carrying the play control menu through HTTP, or SIP, or Simple Object Access Protocol (SOAP). The play control instruction mentioned above in Embodiment 1 may also be carried in the modes enumerated above. The mode of carrying messages is not limited herein. Several of the modes will be detailed in the subsequent embodiments.

Step 202: Receive selection information about the menu item selected by the UE.

Step 203: Send a CRBT to the UE according to the selection information.

The foregoing embodiment provides an alternative method for sending play control information on the basis of Embodiment 1, and simplifies the user operation.

### Embodiment 3

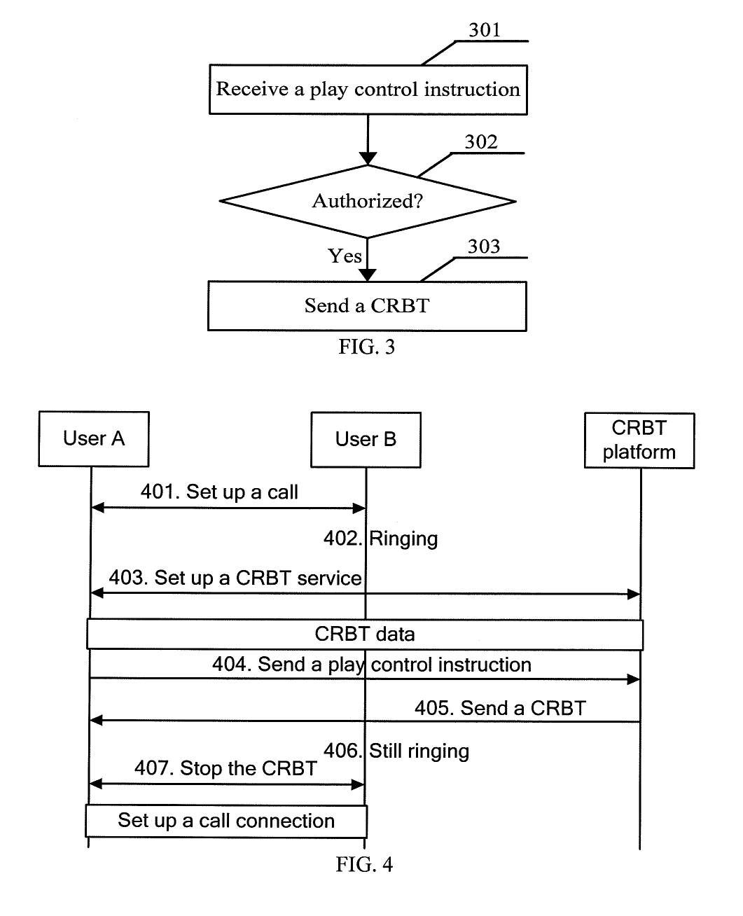

As shown in FIG. 3, an authentication step may be added to the method described in Embodiment 1 to form the method in Embodiment 3:

Step 301: Receive a play control instruction that carries a rights identifier from the UE. The rights identifier indicates whether the UE has the rights to control CRBT play.

Step 302: Determine whether the identifier indicates that the UE has the rights to control CRBT play.

Step 303: Send a CRBT to the UE according to the play control instruction if the identifier indicates that the UE has the rights to control CRBT play.

The authentication step is added to the foregoing embodiment to enhance security.

In the subsequent method embodiments, the conception of the present disclosure is applied to several existing CRBT scenarios. In the subsequent embodiments, user A (UE A) is a calling party, and user B (UE B) is a called party.

### Embodiment 4

As shown in FIG. 4, in the case that user B has customized a CRBT service or a Customized Alerting Tone (CAT) service, the procedure may be as follows:

Step 401: A call is set up.

Step 402: After the call is set up, user B starts ringing, namely, the called party starts playing the ring tone.

Step 403: A CRBT service is set up. The CRBT connection of user A is set up in this step, and the CRBT data may be transmitted after this step.

Step 404: User A sends a play control instruction to the CRBT platform. The play control instruction may carry a rights identifier.

Step 405: The CRBT platform sends the corresponding CRBT to user A according to the play control instruction in step 404. If the control instruction in step 403 carries a rights identifier, this step needs to include a determining operation, namely, determining whether user A has the rights to control CRBT play; if user A has the rights to control CRBT play, step 405 is performed; if user A does not have the rights to control CRBT play, the CRBT customized by user B may be played to user A, or beeps are played to user A. In this step, a reason for rejecting play control may be sent to user A, or a rejection identifier is sent to user A to indicate rejection of play control. The rights may be set by user B or specified by the system, which shall not be construed as a limitation to the present disclosure.

Step 406: User B is still ringing.

Step 407: When user B goes off-hook to answer the call, the CRBT stops, and a call connection is set up. After this step, the call data may be transmitted. Another procedure for stopping the CRBT play is: User A goes on-hook, the CRBT play stops, and the call connection is cut off. The procedure for stopping the CRBT play shall not be construed as a limitation to the present disclosure.

### Embodiment 5

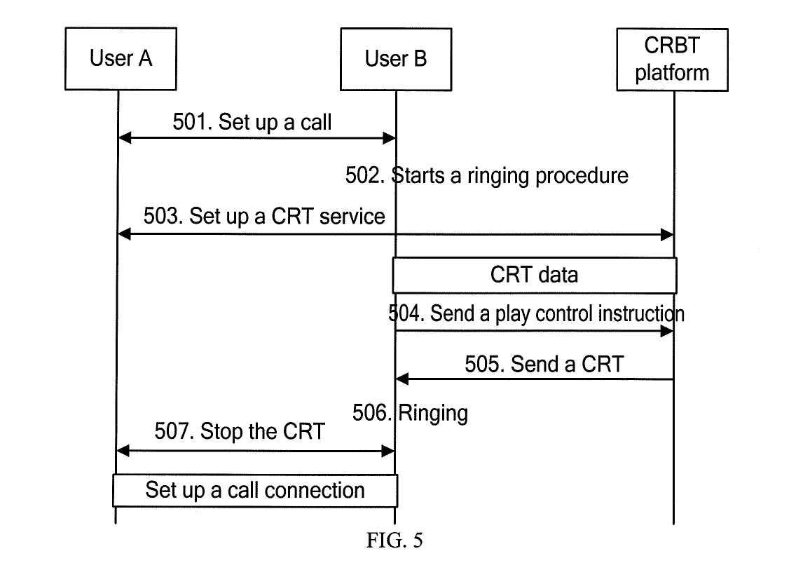

As shown in FIG. 5, in the case that user A has customized a CRT service or a Customized Ringing Signal (CRS) service, the procedure may be as follows:

Step 501: A call is set up.

Step 502: After the call is set up, user B starts a ringing procedure, namely, the called party starts a ringing procedure.

Step 503: A CRT service is set up. The CRT connection of user B is set up in this step, and the CRT data may be transmitted after this step.

Step 504: User B sends a play control instruction to the CRBT platform. The play control instruction may carry a rights identifier.

Step 505: The CRBT platform sends the corresponding CRT to user B according to the play control instruction in step 504. If the control instruction in step 503 carries a rights identifier, this step needs to include a determining operation, namely, determining whether user B has the rights to control CRT play; if user B has the rights to control CRT play, step 505 is performed; if user B does not have the rights to control CRT play, the CRT customized by user A may be played to user B, or beeps are played to user B. In this step, a reason for rejecting play control may be sent to user B, or a rejection identifier is sent to user B to indicate rejection of play control. The rights may be set by user A or specified by the system, which shall not be construed as a limitation to the present disclosure.

Step 506: User B is ringing.

Step 507: When user B goes off-hook to answer the call, the CRT stops, and a call connection is set up. After this step, the call data may be transmitted. Another procedure for stopping the CRT play is: User A goes on-hook, the CRT play stops, and the call connection is cut off. The procedure for stopping the CRT play shall not be construed as a limitation to the present disclosure.

### Embodiment 6

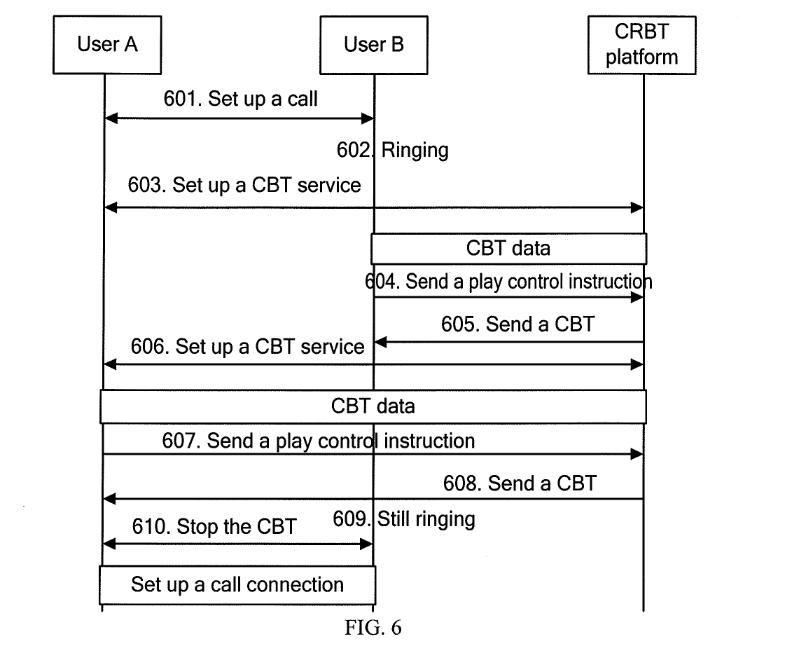

As shown in FIG. 6, in the case that user A and/or user B has customized a CBT service (in this embodiment, both user A and user B have customized a CBT service), the procedure may be as follows:

Step 601: A call is set up.

Step 602: After the call is set up, user B starts ringing, namely, the called party starts playing the ring tone.

Step 603: A CBT service is set up. The CBT connection of user B is set up in this step, and the CBT data may be transmitted after this step.

Step 604: User B sends a play control instruction to the CRBT platform. The play control instruction may carry a rights identifier.

Step 605: The CRBT platform sends the corresponding CBT to user B according to the play control instruction in step 604; if the control instruction sent in step 604 carries a rights identifier, this step needs to include a determining operation, namely, determining whether user B has the rights to control CBT play. If user B has the rights to control CBT play, step 605 described above is performed.

Step 606: A CBT service is set up. The CBT connection of user A is set up in this step, and the CBT data may be transmitted after this step.

Step 607: User A sends a play control instruction to the CRBT platform. The play control instruction may carry a rights identifier.

Step 608: The CRBT platform sends the corresponding CBT to user A according to the play control instruction in step 607; if the control instruction sent in step 607 carries a rights identifier, this step needs to include a determining operation, namely, determining whether user A has the rights to control CBT play. If user A has the rights to control CBT play, step 608 described above is performed.

Steps 603-605 are independent of steps 606-608, and no fixed logical sequence exists, that is steps 603-605 may be performed before or after steps 606-608, and may also be performed at the same time as steps 606-608.

Step 609: User B is still ringing.

Step 610: When user B goes off-hook to answer the call, the CBT stops, and a call connection is set up. After this step, the call data may be transmitted. Another procedure for stopping the CBT play is: User A goes on-hook, the CBT play stops, and the call connection is cut off. The procedure for stopping the CBT play shall not be construed as a limitation to the present disclosure.

The embodiments from Embodiment 4 to Embodiment 6 describe several scenarios. Through the information interaction between the CRBT receiving terminal and the CRBT playing terminal, the CRBT receiving terminal can control the play of the CRBT, and the user experience of the CRBT receiving terminal is improved.

### Embodiment 7

This embodiment provides the format of the play control instruction mentioned in the foregoing embodiments, and the format of the response to the play control instruction:

Table 1 shows the message format of a play control instruction:

TABLE 1
Play control instruction

| Field | Description | Value | Remarks |
|---|---|---|---|
| SQNO | Sequence | 1 to 127; | This field indicates an |
| | number | This field is optional. | interaction. |
| Optiontype | Operation | 1: play; 2: pause; 3: stop; 4: next; | The UE operation may be |
| | code | 5: previous; 6: last; 7: first; 8: | sent to the server through |
| | | volume up; 9; volume down; 10: | an operation code, and |
| | | full screen of video; 11: | the server resolves the |
| | | minimized screen of video; 12: | operation code to |
| | | pause video; 13: close video; 14: | understand the operation |
| | | close audio; 15: play video; 16: | instruction of the user and |
| | | play audio; 17: close text | exercise media control. |
| | | information; 18: play text | |
| | | information. | |
| | | This field is generally required. | |
| UserID | User | A telephone number or | This field indicates the ID |
| | identifier | information that represents the | of the message sender, |
| | | UE ID. | and may be a telephone |
| | | This field is optional. | number, a SIP URI, an |
| | | | email address, or other |
| | | | information that |
| | | | represents the user ID. |
| Parameter | Parameter | Parameter data structure, for | Parameter information |
| | data | example, Full, Maximum, | indicative of the |
| | | Minimum, 50%. | corresponding operation |
| | | This field is optional. | type. For example, if the |
| | | | operation type is “play”, |
| | | | the value “Full” of this |
| | | | parameter indicates |
| | | | full-screen play; if the |
| | | | operation type is “play |
| | | | audio”, the value “50%” |
| | | | of this parameter |
| | | | indicates that the volume |
| | | | is 50%. |

Table 2 shows the format of a response message returned by a CRBT platform in response to the play control instruction

TABLE 2
Response message

| Field | Description | Value | Remarks |
|---|---|---|---|
| SQNO | Sequence | 1 to 127; | This field indicates an |
| | number | This field is optional. | interaction. |
| Status | Instruction | OK: successful acceptance; NO: | This field indicates |
| | status | not acceptable. | whether the control |
| | | This field is generally required. | instruction information is |
| | | | acceptable. |
| Reason | Reason | If the value of “Status” is NO, the | This field indicates the |
| | | reason may be specified. | reason for rejection. |
| | | This field is optional. | |

It is understandable that, the field names and the corresponding operations in the foregoing tables shall not be construed as limitations to the present disclosure. For example, the sequence number of the operation code in Table 1, the corresponding operation and its sequence may be arranged in other ways.

The foregoing embodiments give examples of the format of the play control instruction and the format of the response to the instruction, and the format is applicable to Embodiment 1 to Embodiment 6. Through the information interaction between the CRBT receiving terminal and the CRBT playing terminal, the CRBT receiving terminal can control the play of the CRBT, and the user experience of the CRBT receiving terminal is improved.

### Embodiment 8

This embodiment provides the modes of transmitting the play control message and its response message described in Embodiment 7, and gives more detailed implementation modes.

The foregoing data messages may be carried through an extended Facility message, namely, through a newly added type or an extended type of the Facility message.

The data messages may be carried through USSD, or SMS, or other call signal.

In an IP Multimedia Subsystem (IMS) or a Next General Network (NGN) or other Public Switched (PS) networks, the data messages may be carried in the following way:

In a SIP network, an extended header field specified in SIP carries the data messages. For example, an extended header field which is extended in the specified method carries the data messages in the call process. The specified method may be a Refer or Notify method. The extended header field may be P-CMR-Optiontype, P-CMR-SONO, P-CMR-UserID, P-CMR-Parameter, P-CMR-Status, or P-CMR-Reason. Such header fields correspond to the fields of the message defined in Embodiment 7.

In the SIP network, the data messages may be carried through an XML document or through HTTP in the specified method. The document type definition (DTD) of the XML document may be:

<?xml version=“1.0” encoding=“UTF-8”?>
<!-- edited with XML -->
<!ELEMENT CMR-OPTION-Req EMPTY>
<!ATTLIST CMR-OPTION-Req
SQNO CDATA #IMPLIED

Optiontype (play|pause|stop|next|previous|last|first|volume up|volume down|full screen of video|minimized screen of video|pause video|close video|close audio|play video|play audio|close text information|play text information) #REQUIRED

UserID CDATA #IMPLIED
Parameter CDATA #IMPLIED

>
<!ELEMENT CMR-OPTION-Rep EMPTY>
<!ATTLIST CMR-OPTION-Rep

SQNO CDATA #IMPLIED
Status (Yes | No) #REQUIRED
Reason CDATA #IMPLIED

>

An instance XML document of this DTD is given below:

The following request message in the current session 11 indicates the user 13900110101 expects to play a video, and the video play starts from 50s.

<?xml version=“1.0” encoding=“UTF-8”?>
<!-- edited with XML -->
<!DOCTYPE CMR-OPTION-Req SYSTEM “.\CMR-OPTION.dtd”>
<!--The request message in the current session 11 indicates the user

13900110101 expects to play a video, and the video play starts from
50s. -->

<CMR-OPTION-Req SQNO=“11” Optiontype=“play video”

UserID=“13900110101” Parameter=“50s”/>

The following message is a response to the request message whose SQNO is 11, and the response message indicates rejection of the operation because the user is not authorized.

<?xml version=“1.0” encoding=“UTF-8”?>
<!-- edited with XML -->
<!DOCTYPE CMR-OPTION-Rep SYSTEM “.\CMR-OPTION.dtd”>
<!--The following message is a response to the request message

whose SQNO is 11, and the response message indicates rejection of the
operation because the user is not authorized-->

<CMR-OPTION-Rep SQNO=“11” Status=“No”
Reason=“unauthorized”/>

### Embodiment 9

This embodiment deals with how a CRBT platform sends a play control menu to the CRBT receiving terminal. It is assumed that the user performs interactive operations on the CRBT platform through DTMF and controls play of media. The CRBT platform may also be another server on the network.

At proper time in the communication process, the server may deliver a play control menu to the user. The play control menu indicates the current interactive operation options to the user. Each option corresponds to a DTMF signal. The user presses a key to trigger the DTMF and implements interactive feedback to the server. The server understands the user operation intention according to the menu currently available to the user and the menu item selected by the user through a DTMF feedback signal, and then the server performs media play control for the user. Alternatively, the play control menu may be transmitted through SMS or USSD.

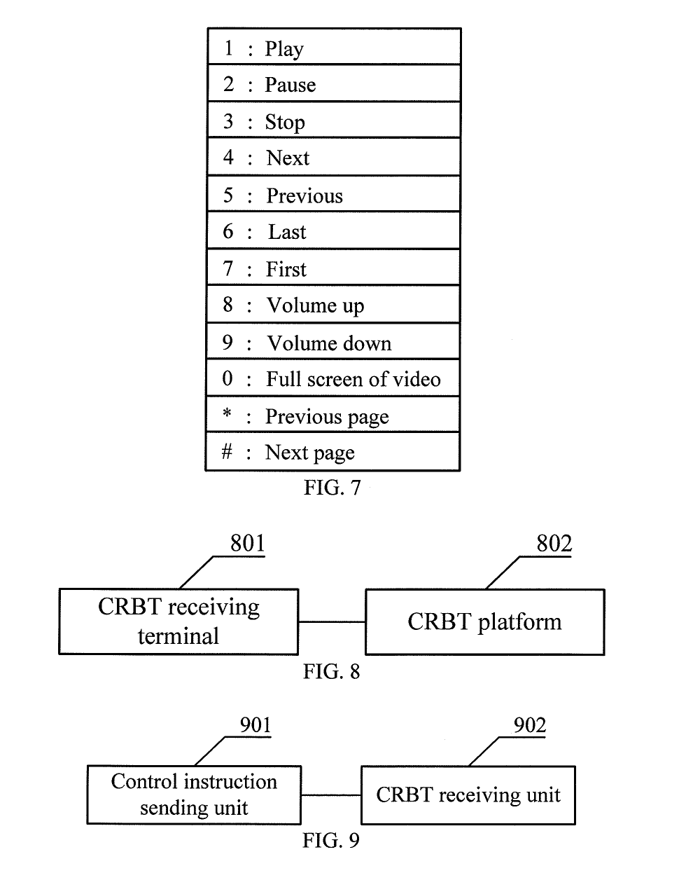

FIG. 7 shows an instance of the play control menu. The user may press a DTMF key such as 0-9, *, and # to perform the operation. The server receives the DTMF signal to know the operation intention of the UE according to the current menu, thus implementing the interaction between the UE and the server. It is understandable that the specific style of the menu shall not be construed as a limitation to the present disclosure. The number of options and the sequence of the operation items are variable.

The foregoing embodiment expounds the method of sending relevant information. In Embodiment 1 to Embodiment 6, through the information interaction between the CRBT receiving terminal and the CRBT playing terminal, the CRBT receiving terminal can control the play of the CRBT, and the user experience of the CRBT receiving terminal is improved.

### Embodiment 10

FIG. 8 shows a system for controlling play of a CRBT service. The system includes:

a CRBT receiving terminal 801, configured to send a play control instruction to a CRBT platform 802, and obtain a CRBT sent by the CRBT platform 802 according to the play control instruction; and

the CRBT platform 802, configured to send the CRBT to the CRBT receiving terminal 801 according to the play control instruction.

When the CRBT platform 802 sends a play control menu to the CRBT receiving terminal 801, the CRBT receiving terminal 801 is further configured to receive the play control menu; select an item from the play control menu, and send selection information about the selected item to the CRBT platform 802; and receive the CRBT sent by the CRBT platform 802 according to the selection information; and

the CRBT platform 802 is further configured to send the play control menu to the CRBT receiving terminal 801; receive the selection information sent by the CRBT receiving terminal 801, and send a CRBT to the CRBT receiving terminal 801 according to the selection information.

If the play control instruction carries a rights identifier which indicates whether the CRBT receiving terminal has the rights to control CRBT play, the CRBT platform 802 is further configured to determine whether the identifier indicates that the CRBT receiving terminal 801 has the rights to control CRBT play; and, if the identifier indicates that the CRBT receiving terminal 801 has the rights to control CRBT play, send a CRBT to the CRBT receiving terminal 801 according to the play control instruction.

### Embodiment 11

As shown in FIG. 9, a UE provided in this embodiment includes:

a control instruction sending unit 901, configured to send a play control instruction to a CRBT platform; and

a CRBT receiving unit 902, configured to obtain a CRBT sent by the CRBT platform according to the play control instruction.

### Embodiment 12

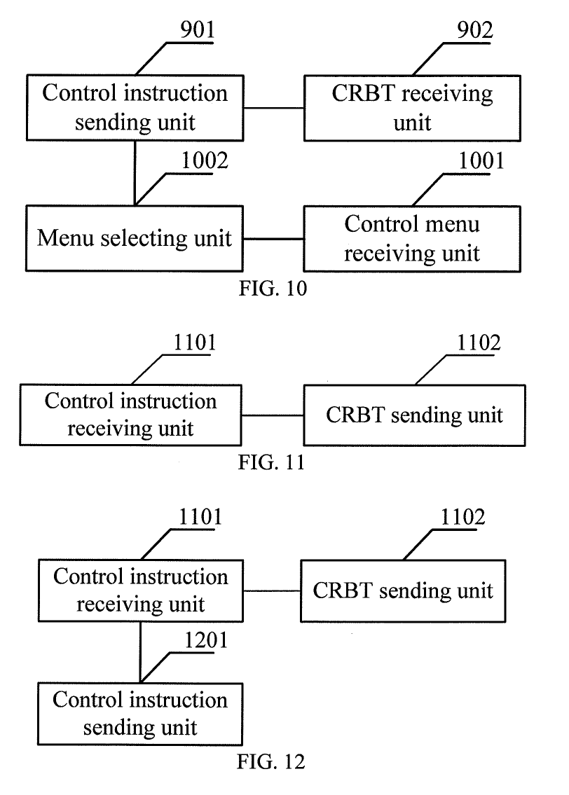

As shown in FIG. 10, the UE provided in Embodiment 11 may further include:

a control menu receiving unit 1001, configured to receive a play control menu;

a menu selecting unit 1002, configured to select an item from the play control menu;

the control instruction sending unit 901, further configured to send selection information about the selected item to the CRBT platform; and

the CRBT receiving unit 902, further configured to receive the CRBT sent by the CRBT platform according to the selection information.

### Embodiment 13

As shown in FIG. 11, a CRBT platform provided in this embodiment includes:

a control instruction receiving unit 1101, configured to receive a play control instruction sent by a CRBT receiving terminal; and

a CRBT sending unit 1102, configured to send a CRBT according to the play control instruction.

The play control instruction sent by the CRBT receiving terminal 801 carries a rights identifier.

When the rights identifier indicates whether the CRBT receiving terminal 801 has the rights to control CRBT play, the CRBT sending unit 1102 is further configured to determine whether the identifier indicates that the CRBT receiving terminal 801 has the rights to control CRBT play; and, if the CRBT receiving terminal 801 has the rights to control CRBT play, send a CRBT to the CRBT receiving terminal 801 according to the play control instruction.

### Embodiment 14

As shown in FIG. 12, the CRBT platform provided in Embodiment 13 may further include:

a control menu sending unit 1201, configured to send a play control menu to the CRBT receiving terminal 801;

the control instruction receiving unit 1101, further configured to receive selection information about the item selected by the CRBT receiving terminal 801 among the play control menus; and

the CRBT sending unit 1102, further configured to send the CRBT to the CRBT receiving terminal 801 according to the selection information.

Through the information interaction between the CRBT receiving terminal and the CRBT playing terminal in the foregoing embodiment, the CRBT receiving terminal can control the play of the CRBT, and the user experience of the CRBT receiving terminal is improved.

Persons of ordinary skill in the art should understand that all or a part of the steps of the method in the embodiments of the present disclosure may be implemented by a program instructing relevant hardware. The program may be stored in a computer readable storage medium. The storage medium may be a Read-Only Memory (ROM), a magnetic disk, or a Compact Disk-Read Only Memory (CD-ROM).

Detailed above are a method, a system, and an apparatus for controlling play of CRBT services under the present disclosure. Although the disclosure is described through some exemplary embodiments, the disclosure is not limited to such embodiments. It is apparent that those skilled in the art can make modifications and variations to the disclosure without departing from the spirit and scope of the disclosure. The disclosure is intended to cover the modifications and variations provided that they fall within the scope of protection defined by the following claims or their equivalents.

What is claimed is:

1. A method for controlling play of a Customized Ring Back Tone (CRBT) service, comprising:
receiving a play control instruction from a CRBT receiving terminal; and
sending a CRBT to the CRBT receiving terminal according to the play control instruction.

2. The method according to claim 1, wherein:
the received play control instruction is carried in a Session Initiation Protocol (SIP) header field; or
the play control instruction is carried in an Extensible Markup Language (XML) document.

3. The method according to claim 2, wherein:
the XML document is carried in a Hyper Text Transfer Protocol (HTTP) field.

4. The method according to claim 1, wherein: before receiving the play control instruction from the CRBT receiving terminal, the method further comprises:
sending a play control menu to the CRBT receiving terminal;
the step of receiving the play control instruction from the CRBT receiving terminal comprises: receiving selection information about an item selected by the CRBT receiving terminal from the play control menu; and
the step of sending the CRBT to the CRBT receiving terminal according to the play control instruction comprises: sending the CRBT to the CRBT receiving terminal according to the selection information.

5. The method according to claim 4, wherein the step of sending the play control menu comprises one of the following:
sending the play control menu carried through a Packet Switched (PS) protocol; and
sending the play control menu carried through a Circuit Switched (CS) protocol.

6. The method according to claim 1, wherein the step of sending the play control instruction comprises one of the following:
sending the play control instruction carried through a Circuit Switched (CS) protocol; and
sending the play control instruction carried through a Packet Switched (PS) protocol.

7. The method according to claim 5, wherein the carrying through the CS protocol comprises one of the following:
carrying through Dual Tone Multi Frequency (DTMF);
carrying through Short Message Service (SMS);
carrying through Unstructured Supplementary Service Data (USSD); and
carrying through a supplementary service indication message.

8. The method according to claim 5, wherein the carrying through the PS protocol comprises one of the following:
carrying through a Hyper Text Transfer Protocol (HTTP);
carrying through a Session Initiation Protocol (SIP); and
carrying through a Simple Object Access Protocol (SOAP).

9. The method according to claim 6, wherein the carrying through the CS protocol comprises one of the following:
carrying through Dual Tone Multi Frequency (DTMF);
carrying through Short Message Service (SMS);
carrying through Unstructured Supplementary Service Data (USSD); and
carrying through a supplementary service indication message;
wherein the carrying through the PS protocol comprises one of the following:
carrying through a Hyper Text Transfer Protocol (HTTP);
carrying through a Session Initiation Protocol (SIP); and
carrying through a Simple Object Access Protocol (SOAP).

10. The method according to claim 1, wherein:
the step of receiving the play control instruction from the CRBT receiving terminal comprises: receiving the play control instruction from the CRBT receiving terminal, the play control instruction comprising a rights identifier, wherein the rights identifier indicates whether the CRBT receiving terminal has rights to control CRBT play; and
before sending the CRBT to the CRBT receiving terminal according to the play control instruction, the method further comprises: determining whether the identifier indicates that the CRBT receiving terminal has the rights to control CRBT play; and, if the identifier indicates that the CRBT receiving terminal has the rights to control CRBT play, sending the CRBT to the CRBT receiving terminal according to the play control instruction.

11. The method according to claim 2, wherein:
the step of receiving the play control instruction from the CRBT receiving unit comprises: receiving the play control instruction from the CRBT receiving terminal, the play control instruction comprising a rights identifier, wherein the rights identifier indicates whether the CRBT receiving terminal has rights to control CRBT play; and
before sending the CRBT to the CRBT receiving terminal according to the play control instruction, the method further comprises: determining whether the identifier indicates that the CRBT receiving terminal has the rights to control CRBT play; and, if the identifier indicates that the CRBT receiving terminal has the rights to control CRBT play, sending the CRBT to the CRBT receiving terminal according to the play control instruction.

12. The method according to claim 3, wherein:
the step of receiving the play control instruction from the CRBT receiving terminal comprises: receiving the play control instruction from the CRBT receiving terminal, the play control instruction comprising a rights identifier, wherein the rights identifier indicates whether the CRBT receiving terminal has rights to control CRBT play; and
before sending the CRBT to the CRBT receiving terminal according to the play control instruction, the method further comprises: determining whether the identifier indicates that the CRBT receiving terminal has the rights to control CRBT play; and, if the identifier indicates that the CRBT receiving terminal has the rights to control CRBT play, sending the CRBT to the CRBT receiving terminal according to the play control instruction.

13. A system for controlling play of a Customized Ring Back Tone (CRBT) service, comprising:
a CRBT receiving terminal, configured to send a play control instruction to a CRBT platform, and obtain a CRBT from the CRBT platform according to the play control instruction; and
the CRBT platform, configured to send the CRBT to the CRBT receiving terminal according to the play control instruction.

14. The system according to claim 13, wherein:
the CRBT receiving terminal is further configured to receive a play control menu; select an item from the play control menu, and send selection information about the selected item to the CRBT platform; and receive the CRBT sent by the CRBT platform according to the selection information; and
the CRBT platform is further configured to send the play control menu to the CRBT receiving terminal; receive the selection information sent by the CRBT receiving terminal, and send the CRBT to the CRBT receiving terminal according to the selection information.

15. The system according to claim 13, wherein:
the play control instruction carries a rights identifier that indicates whether the CRBT receiving terminal has rights to control CRBT play; and
the CRBT platform is further configured to determine whether the identifier indicates that the CRBT receiving terminal has the rights to control CRBT play; and, if the identifier indicates that the CRBT receiving terminal has the rights to control CRBT play, send the CRBT to the CRBT receiving terminal according to the play control instruction.

16. A User Equipment (UE), comprising:
a control instruction sending unit, configured to send a play control instruction to a Customized Ring Back Tone (CRBT) platform; and
a CRBT receiving unit, configured to obtain a CRBT sent by the CRBT platform according to the play control instruction.

17. The UE according to claim 16, further comprising:
a control menu receiving unit, configured to receive a play control menu;
a menu selecting unit, configured to select an item from the play control menu;
the control instruction sending unit, further configured to send selection information about the selected item to the CRBT platform; and
the CRBT receiving unit, further configured to receive the CRBT sent by the CRBT platform according to the selection information.

18. A Customized Ring Back Tone (CRBT) platform, comprising:
a control instruction receiving unit, configured to receive a play control instruction sent by a CRBT receiving terminal; and
a CRBT sending unit, configured to send a CRBT according to the play control instruction.

19. The CRBT platform according to claim 18, further comprising:
a control menu sending unit, configured to send a play control menu to the CRBT receiving terminal;
the control instruction receiving unit, further configured to receive selection information about an item selected by the CRBT receiving terminal from the play control menu; and
the CRBT sending unit, further configured to send the CRBT to the CRBT receiving terminal according to the selection information.

20. The CRBT platform according to claim 18, wherein:
the play control instruction sent by the CRBT receiving terminal carries a rights identifier, and the rights identifier indicates whether the CRBT receiving terminal has rights to control CRBT play; and
the CRBT sending unit is further configured to determine whether the identifier indicates that the CRBT receiving terminal has the rights to control CRBT play; and, if the identifier indicates that the CRBT receiving terminal has the rights to control CRBT play, send the CRBT to the CRBT receiving terminal according to the play control instruction.
